(19) United States
(12) Patent Application Publication
(10) Pub. No.: US 2011/0281597 A1
(43) Pub. Date: Nov. 17, 2011

(54) AIDED CONSTRUCTION OF SMS STATUS MESSAGES TO CAREGIVERS

(75) Inventor: Ajit Pendse, Durham, NC (US)

(73) Assignee: pomdevices, LLC, Durham, NC (US)

(21) Appl. No.: 13/102,300

(22) Filed: May 6, 2011

Related U.S. Application Data
(60) Provisional application No. 61/333,598, filed on May 11, 2010.

(51) Int. Cl. H04W 4/12

(52) U.S. Cl. 455/466

(57) ABSTRACT

In one example, a portable device displays a first subset of a set of predefined text statements, and receives a user selection of one of the displayed text statements over an input interface of the portable device. Conditionally based on which one of the displayed text statements is identified by the user selection, the portable device displays a second subset of the set of predefined text statements on the display of the portable device. The portable device then generates a text message with user data containing text taken from at least a particular one of the set of predefined text statements according to the received user selection(s).

This application is a non-provisional of U.S. Provisional Application No. 61/333,598 filed on May 11, 2010, entitled: AIDED CONSTRUCTION OF SMS STATUS MESSAGES TO CAREGIVERS, which is herein incorporated by reference in its entirety.

### COPYRIGHT NOTICE

©2011 pomdevices, LLC. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### BACKGROUND OF THE INVENTION

SMS (sometimes known as “short message service” or “text messaging”) is a common technique for communication of short messages in a networked environment, for example among mobile phone devices. Simple and convenient, text messaging is seen as a new standard by many for sending status, proximity, and other types of one-way information. Indeed, billions of text messages are now sent monthly in the United States alone.

Most text messaging devices, however, present technological hurdles to the older adult. Navigating complex menus, interacting with small screens and keyboards, and understanding the underlying technology involved in SMS messaging can lead to a lack of participation in the older population. The disclosure that follows solves this and other problems.

### SUMMARY OF THE INVENTION

In one example, a portable device displays a first subset of a set of predefined text statements, and receives a user selection of one of the displayed text statements over an input interface of the portable device. Conditionally based on which one of the displayed text statements is identified by the user selection, the portable device displays a second subset of the set of predefined text statements on the display of the portable device. The portable device then generates a text message with user data containing text taken from at least a particular one of the set of predefined text statements according to the received user selection(s).

### BRIEF DESCRIPTION OF THE DRAWINGS

FIG. 1 illustrates a system for aided construction of SMS status messages to caregivers.

FIG. 2A illustrates a timeline of an example operation of the portable device of FIG. 1.

FIG. 2B illustrates example screens displayed by the portable device during the example operation of FIG. 2A.

FIG. 3 illustrates an example method for using the portable device illustrated in FIG. 1.

FIG. 4 illustrates an example method for using the caregiver computing device illustrated in FIG. 1.

### DETAILED DESCRIPTION OF PREFERRED EMBODIMENTS

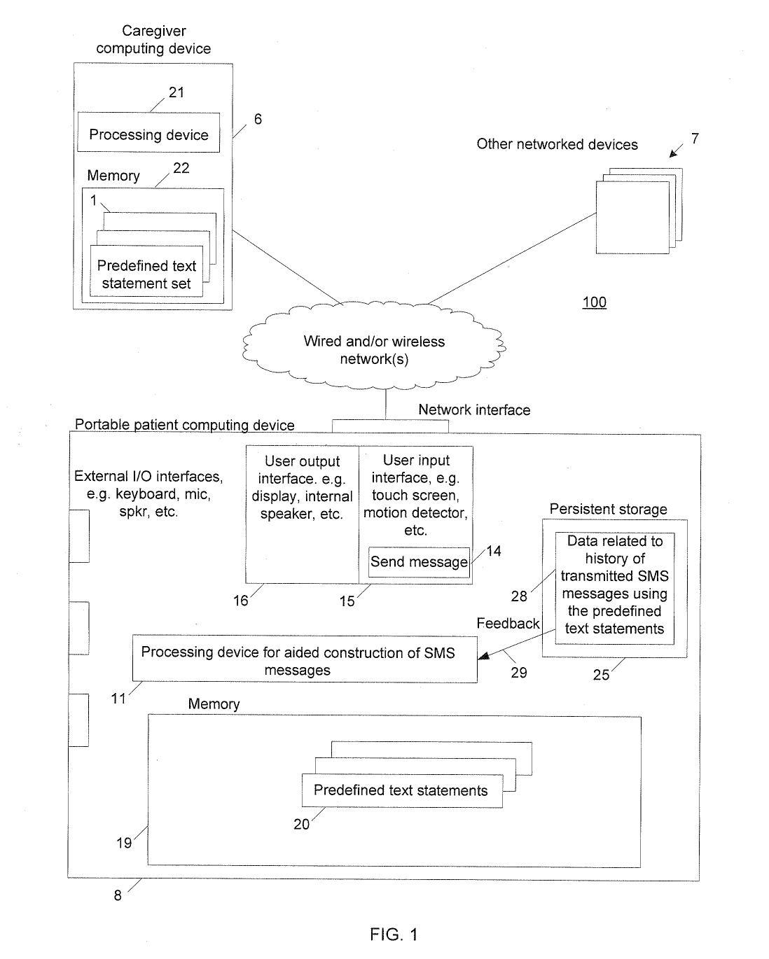

FIG. 1 illustrates a system for aided construction of SMS status messages to caregivers.

The system 100 includes a caregiver computing device 6 and a portable device 8 to be used by a patient or other monitored user. The computing device 6 and the portable device 8 include specially configured processing devices 21 and 11, respectively, which will be described later in greater detail.

The system 100 can include conventional networked devices 7 including, but not limited to, a personal portable device (cell phone, PDA, etc.), a laptop, a desktop workstation, etc. The processing device 11 is configured for aided construction of SMS messages addressed to the networked devices 7 and/or the caregiver computing device 6.

The portable patient computing device 8 includes a memory 19 containing a plurality of predefined text statements 20. In one example, the predefined text statements 20 include at least four predefined text statements, namely a first predefined text statement that recites a first status of a patient or other monitored user, a second predefined text statement that recites a second different status of the monitored user, a third predefined text statement that recites a first need of the monitored user, and a fourth predefined text statement that recites a second different need of the monitored user. The at least first and second predefined text statements could include “feel good”, “feel OK”, “not so good”, or any other status indications providing alternative statuses. The at least third and fourth predefined text statements could include a need such as an item, e.g. “groceries” or “medicine”, or a need such as a request for contact with alternative urgencies such as “please call me today” or “please call me when you get a chance”.

In some examples, the particular combination of the predefined text statements 20 stored in the memory 19 corresponds to one of the predefined text statement sets 1 stored in the memory 22 of the remote device 6. In such examples, the processing device 21 can obtain information regarding a characteristic of the operator (patient or other monitored user) of the portable device 8 from any source such as via a communication from the processing device 11 or via an input over a local user interface 15 (a touch screen, a keyboard, a microphone in the case of a voice recognition system, etc.) of the caregiver computing device 6. The characteristic can be any information taken from a profile of the operator, such as a level of care needed by the operator in one example. The processing device 21 selects a particular one of the sets 1 based on the obtained information. The selection by the processing device 21 controls which of the predefined text statements 20 are available to the processing device 11 for displaying to the operator.

The portable patient computing device 8 may contain persistent storage 25 for retaining data 28 related to a history of transmitted SMS messages containing the predefined text statements. For example, the data 28 can contain send times of previously transmitted text messages with predefined text statement(s) 20 included therein and an indication of which ones of the predefined text statement(s) 20 were included in each text message.

The processing device 11 is configured to analyze the data 28 at times. The processing device 11 is configured to use a result of the analysis to adjust aided construction of future text messages (illustrated as feedback 29). For example, according to the analysis the processing device 11 may identify a trend such as a plurality of text messages containing the same one or ones of the predefined text statements 20 sent at regular intervals. The processing device 11 is configured to then schedule a proposed text message based on the identified statements to be displayed based on a display 16 of the device 8 at the next occurrence of the regular interval with a request for confirmation to send the proposed message, or in some examples the processing device 11 can be configured to automatically (without manual user intervention) send the system generated text message at the scheduled time.

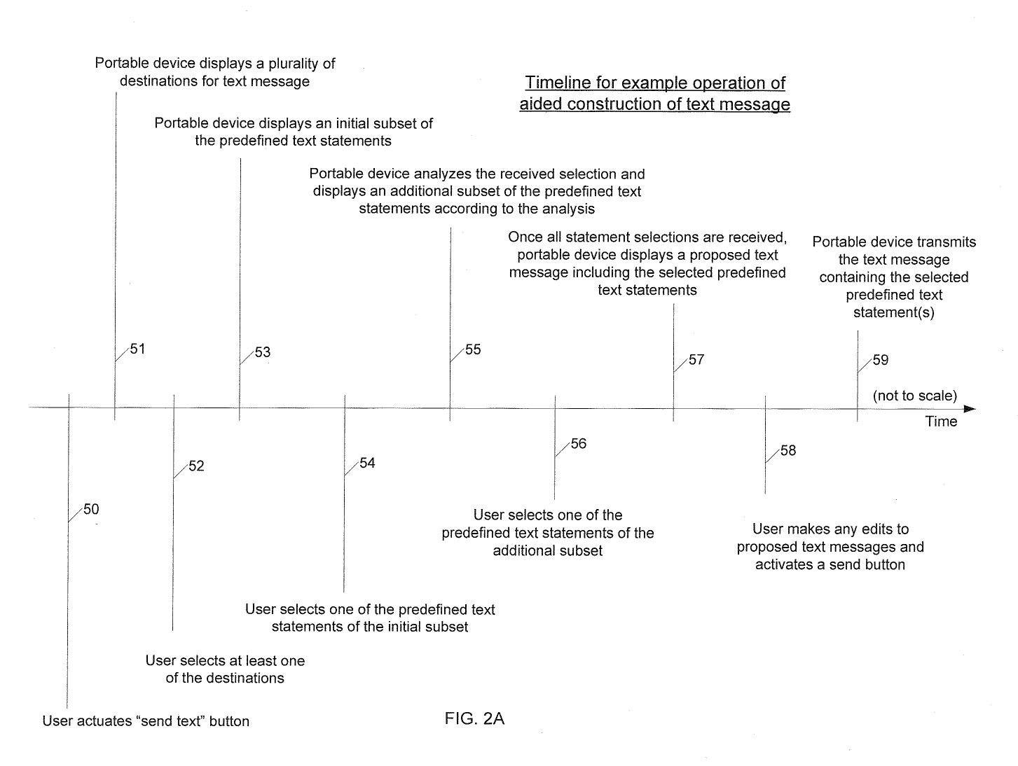

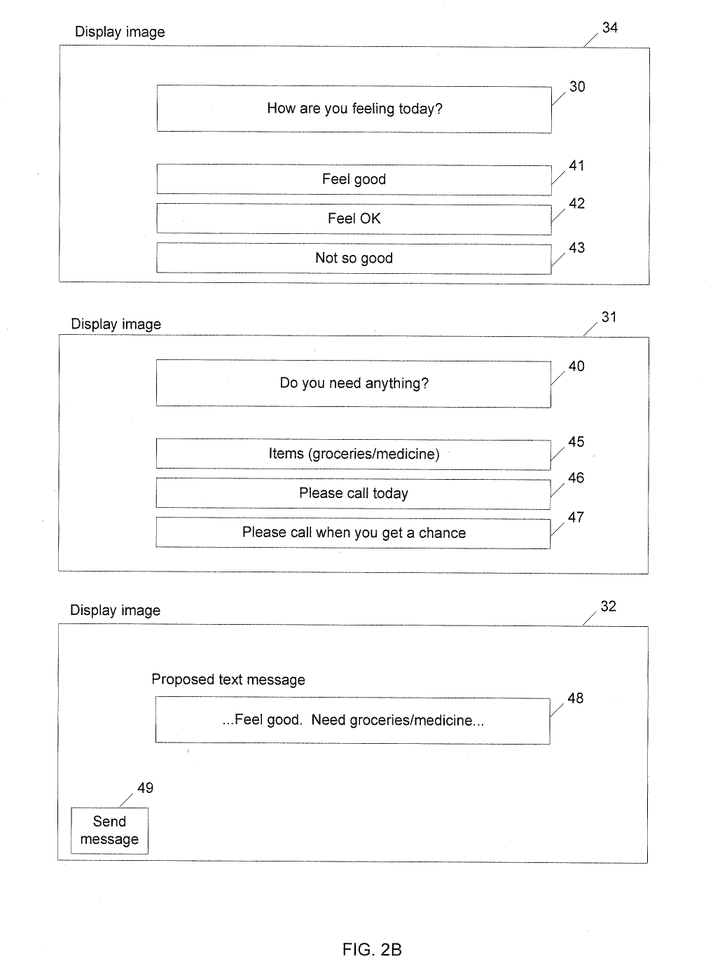

Having described various components of the system 100, an example operation will now be discussed with reference to FIG. 2A (a timeline for the example operation of the portable device of FIG. 1) and FIG. 2B (example screens displayed on the portable device of FIG. 1) for purposes of further describing these components.

Referring to FIG. 2A, at time 50 the user actuates a “send text” button, which can be a physical user interface component on a surface of the portable device shell or any other user interface component. At time 51, the portable device displays a plurality of destinations for the text message. At time 52, the user selects at least one of the destinations.

At time 53, the portable device displays an initial subset of the predefined text statements. Referring to FIG. 2B, an example image 34 for this displaying is shown. The example image 34 includes a query field 30 to elicit selection of one of the three displayed predefined text statements 41-43. The user can select any one of the three displayed predefined text statements 41-43 using any known user interface such as a touch screen.

Referring again to FIG. 2A, at time 54 the user selects one of the predefined text statements of the initial subset. At time 55, the portable device analyzes the received selection and displays an additional subset of the predefined text statements according to the analysis. For example, referring to FIG. 2B, if the user selects either statement 41 or 42 (but not statement 43), then the display image 31 is shown. The display image 31 has a query field 40 and statements 45-47 of the additional subset. Selection of statement 43 might cause a different subset than statements 45-47 to be displayed in the image 31.

Referring again to FIG. 2A, at time 56 the user selects one of the predefined text statements of the additional subset. This could include activating a touch input interface such as a button or speaking a selection such as “choose one”, “choose two”, or “choose three” in the case of a voice recognition option. The times 55 and 56 are intended to represent some number N cycles of displaying additional predefined text statements and obtaining a user selection, where N can be 0, 1, 2, 3, etc. depending on the initial selection.

At time 57, once all the statement selections are received, the portable device displays a proposed text message including the selected predefined text statements as shown in FIG. 2B, image 32. The image 32 includes the proposed text message 48 and a send message soft button 49. The proposed text message 48 includes the teiins “feel good” and “need groceries/medicine” as shown if the user selected statements 41 and 45. The user can manually edit the proposed message to include, for example, other inputs before and/or after the predefined text statements.

At time 58, a user can submit any edits to the proposed text message before sending a confirmation by, for example, actuating a soft button (49 in FIG. 2B) or re-actuating the physical “send text” button (14 in FIG. 1). At time 59, the portable device transmits the text message containing the selected predefined text statement(s) to the selected destination(s).

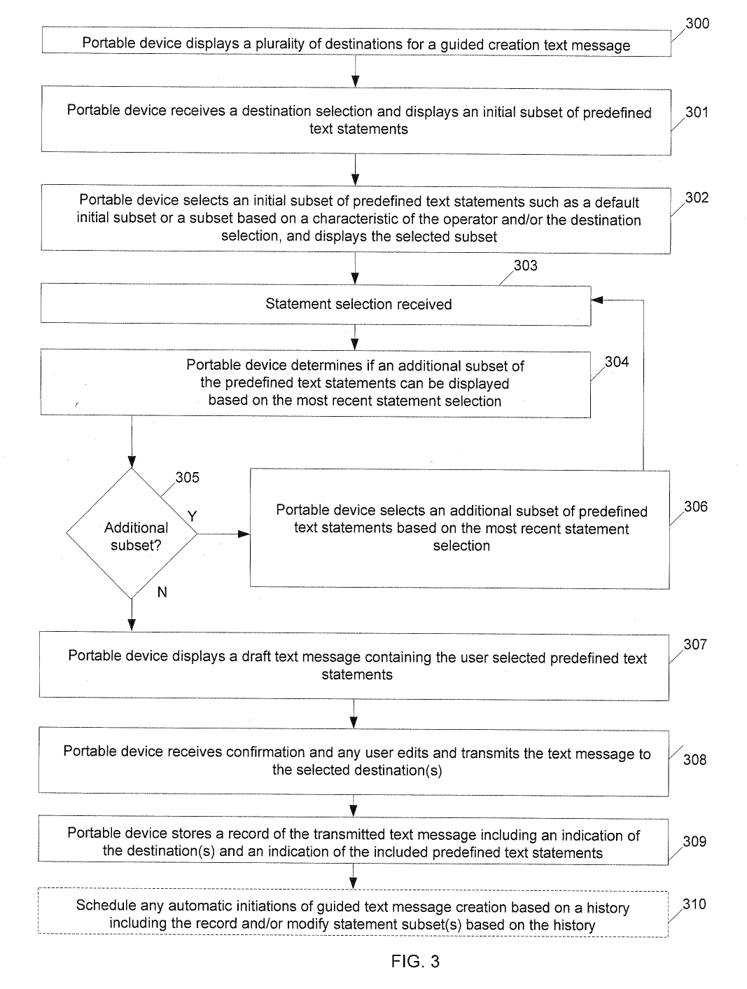

FIG. 3 illustrates an example method for using the portable device illustrated in FIG. 1.

In block 300, the portable device displays a plurality of destinations for a guided creation text message. In block 301, the portable device receives a destination selection and displays an initial subset of predefined text statements.

In block 302, the portable device selects an initial subset of the predefined text statements such as a default initial subset or a subset based on a characteristic of the operator and/or the destination selection, and displays the selected subset. In block 303, the portable device receives a statement selection. In block 304, the portable device determines if an additional subset of the predefined text statements can be displayed based on the most recent statement selection.

If an additional subset can be displayed (diamond 305), then in block 306 the portable device selects an additional subset of predefined text statements based on the most recent statement selection, and displays the selected subset. The process returns to block 303.

Otherwise, if no additional subset can be displayed (diamond 305), then in block 307 the portable device displays a draft text message containing the user selected predefined text statements. In block 308, the portable device receives confirmation and any user edits and transmits the text message to the selected destination(s). In block 309, the portable device stores a record of the transmitted text message including an indication of the selected destination(s) and an indication of the included predefined text statements. In block 310, the portable device can optionally schedule any automatic initiations of guided text message creation based on a history including the record and/or modify statement subset(s) based on the history.

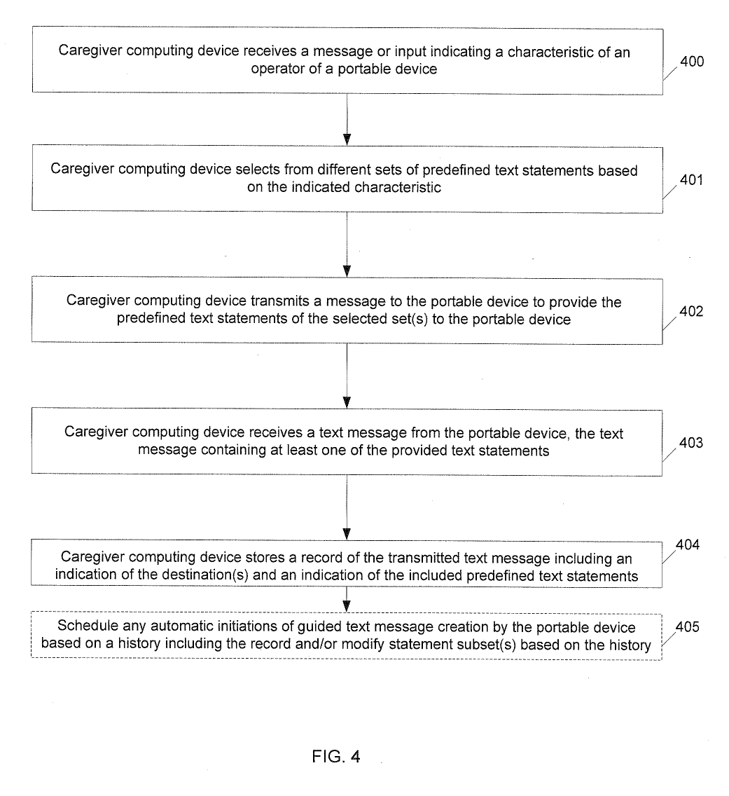

FIG. 4 illustrates an example method for using the caregiver computing device illustrated in FIG. 1.

In block 400, the caregiver computing device receives a message or input indicating a characteristic of an operator of a portable device. In block 401, the caregiver computing device selects from different sets of predefined text statements based on the indicated characteristic. In block 402, the caregiver computing device transmits a message to the portable device to provide the predefined text statements of the selected set(s) to the portable device.

In block 403, the caregiver computing device receives a text message from the portable device, the text message containing at least one of the provided text statements. In block 404, the caregiver computing device stores a record of the transmitted text message including an indication of the destination(s) and an indication of the included predefined text statements. In block 405, the caregiver computing device can optionally schedule any automatic initiations of guided text message creation by the portable device based on a history including the record and/or modify statement set(s) based on the history.

It will be apparent to those having skill in the art that many changes may be made to the details of the above-described embodiments without departing from the underlying principles of the invention. For example, the scope of the present invention should, therefore, be determined only by the following claims.

Most of the equipment discussed above comprises hardware and associated software. For example, the typical portable device is likely to include one or more processors and software executable on those processors to carry out the operations described. We use the (subroutines, objects, plug-ins, etc.), as well as data, usable by a machine or processor. As is well known, computer programs generally comprise instructions that are stored in machine-readable or computer-readable storage media. Some embodiments of the present invention may include executable programs or instructions that are stored in machine-readable or computer-readable storage media, such as a digital memory. We do not imply that a “computer” in the conventional sense is required in any particular embodiment. For example, various processors, embedded or otherwise, may be used in equipment such as the components described herein.

Memory for storing software again is well known. In some embodiments, memory associated with a given processor may be stored in the same physical device as the processor (“on-board” memory); for example, RAM or FLASH memory disposed within an integrated circuit microprocessor or the like. In other examples, the memory comprises an independent device, such as an external disk drive, storage array, or portable FLASH key fob. In such cases, the memory becomes “associated” with the digital processor when the two are operatively coupled together, or in communication with each other, for example by an I/O port, network connection, etc. such that the processor can read a file stored on the memory. Associated memory may be “read only” by design (ROM) or by virtue of permission settings, or not. Other examples include but are not limited to WORM, EPROM, EEPROM, FLASH, etc. Those technologies often are implemented in solid state semiconductor devices. Other memories may comprise moving parts, such as a conventional rotating disk drive. All such memories are “machine readable” or “computer-readable” and may be used to store executable instructions for implementing the functions described herein.

A “software product” refers to a memory device in which a series of executable instructions are stored in a machine-readable form so that a suitable machine or processor, with appropriate access to the software product, can execute the instructions to carry out a process implemented by the instructions. Software products are sometimes used to distribute software. Any type of machine-readable memory, including without limitation those summarized above, may be used to make a software product. That said, it is also known that software can be distributed via electronic transmission (“download”), in which case there typically will be a corresponding software product at the transmitting end of the transmission, or the receiving end, or both.

Having described and illustrated the principles of the invention in a preferred embodiment thereof, it should be apparent that the invention may be modified in arrangement and detail without departing from such principles. We claim all modifications and variations coming within the spirit and scope of the following claims.

1. A portable device, comprising:
a memory storing a plurality of predefined text statements, wherein a first predefined text statement recites a first status of a patient or other monitored user, a second predefined text statement recites a second different status of the monitored user, a third predefined text statement recites a first need of the monitored user, and a fourth predefined text statement recites a second different need of the monitored user; and
a processing device coupled to the memory, the processing device configured to:
display at least the first and second predefined text statements on a display of the portable device;
receive a user selection of one of the displayed text statements;
conditionally based on which one of the displayed text statements is identified by the user selection, display the third predefined text statement and the fourth predefined text statement on the display of the portable device;
if the third predefined text statement and the fourth predefined text statement are displayed on the display of the portable device, receive an additional user selection; and
generate a text message with user data containing text taken from at least a particular one of the predefined text statements stored in the memory according to the received user selection(s).

2. The portable device of claim 1, wherein the processing device is further configured to:
display the text for the user data of the text message on the display of the portable device;
modify the text of the user data according to any received user edits; and
transmit the generated text message.

3. The portable device of claim 1, wherein the processing device is further configured to:
identify a characteristic of the monitored user; and
select which one of a plurality of sets of predefined text statements available on a remote server are stored in the memory according to the identified user characteristic.

4. The portable device of claim 1, wherein the processing device is further configured to:
identify a characteristic of the monitored user; and
select which ones of the predefined text statements from the memory are conditionally displayed according to the characteristic of the monitored user.

5. The portable device of claim 1, wherein the processing device is further configured to:
transmit the text message;
store information relating to the transmitted text message and information relating to previously transmitted guided-creation text messages to form a history of guided-creation text messages;
analyze the stored history of guided-creation text messages; and
automatically display at least the first and second predefined text statements on the display of the portable device at a time selected according to the analysis.

6. The portable device of claim 1, wherein the processing device is further configured to:
transmit the text message;
store information relating to the transmitted text message and information relating to previously transmitted guided-creation text messages to form a history of guided-creation text messages;
analyze the stored history of guided-creation text messages; and
automatically display a proposed new text message, wherein the proposed new text message includes a particular combination of predefined text statements identified according to the analysis.

7. The portable device of claim 6, wherein the processing device is further configured to automatically display the proposed new text message at a time selected according to the analysis.

8. The portable device of claim 1, further comprising a physical user interface dedicated for guided text message generation, wherein the processing device is further configured to display at least the first and second predefined text statements on the display of the portable device responsive to actuation of the physical user interface.

9. The portable device of claim 8, wherein the physical user interface is a button.

10. The portable device of claim 1, wherein the processing device is further configured to:
display a plurality of destinations for the text message; and
in response to receiving a destination selection over a user input interface, control which ones of the predefined text statements stored in the memory are displayed based at least in part on the destination selection.

11. A method, comprising:
displaying a first subset of a set of predefined text statements on a display of a portable device, wherein the set of predefined text statements specifies a plurality of different statuses of a patient or other monitored user and a plurality of different items;
receiving a user selection of one of the displayed text statements over an input interface of the portable device;
conditionally based on which one of the displayed text statements is identified by the user selection, displaying a second subset of the set of predefined text statements on the display of the portable device;
if the second subset is displayed on the display of the portable device, receiving an additional user selection over the input interface of the portable device; and
generating a text message with user data containing text taken from at least a particular one of the set of predefined text statements according to the received user selection(s).

12. The method of claim 11, further comprising:
displaying the text for the user data of the text message on the display of the portable device;
modifying the text of the user data according to any received user edits; and
transmitting the generated text message.

13. The method of claim 11, further comprising:
identifying a characteristic of the monitored user; and
selecting the set used by the portable device from one a plurality of sets of predefined text statements available on a remote server according to the identified user characteristic.

14. The method of claim 11, further comprising:
identifying a characteristic of the monitored user; and
forming the second subset according to the characteristic of the monitored user.

15. The method of claim 11, further comprising:
transmitting the text message;
storing information relating to the transmitted text message and information relating to previously transmitted guided-creation text messages to form a history of guided-creation text messages;
analyzing the stored history of guided-creation text messages; and
automatically displaying the first subset of the set of predefined text statements on the display of the portable device at a time selected according to the analysis.

16. The method of claim 11, further comprising:
transmitting the text message;
storing information relating to the transmitted text message and information relating to previously transmitted guided-creation text messages to form a history of guided-creation text messages;
analyzing the stored history of guided-creation text messages; and
automatically displaying a proposed new text message, wherein the proposed new text message includes a particular combination of predefined text statements identified according to the analysis.

17. The method of claim 16, further comprising automatically displaying the proposed new text message at a time selected according to the analysis.

18. The method of claim 11, further comprising:
displaying a plurality of destinations for the text message; and
in response to receiving a destination selection over the input interface, controlling which ones of the predefined text statements stored in a memory are displayed based at least in part on the destination selection.

19. An apparatus, comprising:
a processing device configured to:
store a plurality of different sets of predefined text statements;
select a particular set of the sets according to a characteristic of a patient or other monitored user assigned as an operator of a portable device;
transmit the particular set to the portable device; and
receive a text message from the portable device, the text message containing at least one of the predefined text statements of the particular set.

20. The apparatus of claim 19, wherein the processing device is further configured to store a record of the text message, the record indicating a destination of the text message and those ones of the predefined text statements contained in the text message.
